(19) United States
(12) Patent Application Publication
(10) Pub. No.: US 2026/0024869 A1
(43) Pub. Date: Jan. 22, 2026

(54) BATTERY PACK VENTING SYSTEM WITH VENT SPOUT

(71) Applicant: Ford Global Technologies, LLC, Dearborn, MI (US)

(72) Inventors: Chung-Hsing Kuo, Ann Arbor, MI (US); Yongcai Wang, Ann Arbor, MI (US)

(21) Appl. No.: 18/774,791

(22) Filed: Jul. 16, 2024

(51) Int. Cl. H01M 50/342; B60L 50/64; H01M 50/211

(52) U.S. Cl. CPC H01M 50/3425; B60L 50/64; H01M 50/211; H01M 2220/20

(57) ABSTRACT

A battery pack venting system includes a cell stack including battery cells disposed along a cell stack axis, and an enclosure assembly providing an interior that houses the cell stack. The enclosure assembly has a first enclosure wall and a plurality of second enclosure walls. The system further includes one or more primary vents in the first enclosure wall, and one or more vent spouts in the first enclosure wall.

### TECHNICAL FIELD

This disclosure relates generally to venting of a traction battery pack, and more particularly, to a venting having at least one primary vent and at least one vent spout.

### BACKGROUND

Electrified vehicles differ from conventional motor vehicles because electrified vehicles are selectively driven using one or more electric machines powered by a traction battery. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

### SUMMARY

In some aspects, the techniques described herein relate to a battery pack venting system, including: a cell stack including a plurality of battery cells disposed along a cell stack axis; an enclosure assembly providing an interior that houses the cell stack, the enclosure assembly having a first enclosure wall and a plurality of second enclosure walls; one or more primary vents in the first enclosure wall; and one or more vent spouts in the first enclosure wall.

In some aspects, the techniques described herein relate to a battery pack venting system, wherein the one or more vent spouts each include a collar that projects away from the interior and circumscribes an vent spout outlet.

In some aspects, the techniques described herein relate to a battery pack venting system, wherein the one or more primary vents each include a primary vent outlet that is a first distance from the interior, and the one or more vent spouts each include a vent spout outlet that is a second distance from the interior, the first distance less than the second distance.

In some aspects, the techniques described herein relate to a battery pack venting system, wherein the one or more vent spouts each include a vent spout outlet that is elevated relative to the one or more primary vents.

In some aspects, the techniques described herein relate to a battery pack venting system, wherein the first enclosure wall is an enclosure cover.

In some aspects, the techniques described herein relate to a battery pack venting system, wherein the enclosure assembly is a cell stack enclosure assembly, and further including a battery pack enclosure assembly that houses the cell stack enclosure assembly.

In some aspects, the techniques described herein relate to a battery pack venting system, wherein the one or more primary vents and the one or more vent spouts open to an interior of the battery pack enclosure assembly that is outside the cell stack enclosure assembly.

In some aspects, the techniques described herein relate to a battery pack venting system, wherein the cell stack enclosure assembly is a first cell stack enclosure assembly, and further including at least one second cell stack enclosure assembly housed within the battery pack enclosure assembly.

In some aspects, the techniques described herein relate to a battery pack venting system, wherein the one or more vent spouts each include a frustoconical portion.

In some aspects, the techniques described herein relate to a battery pack venting system, wherein the one or more primary vents includes a plurality of primary vents disposed along an primary vent axis.

In some aspects, the techniques described herein relate to a battery pack venting system, wherein the one or more vent spouts includes a plurality of vent spouts disposed along a vent spout axis.

In some aspects, the techniques described herein relate to a battery pack venting system, wherein the plurality of vent spouts disposed along a vent spout axis is a first plurality of vent spouts disposed along a first vent spout axis, wherein the one or more vent spouts includes a second plurality of vent spouts disposed along a second vent spout axis.

In some aspects, the techniques described herein relate to a battery pack venting system, wherein the first plurality of vent spouts are on a first side of the plurality of primary vents, wherein the second plurality of vent spouts are on an opposite, second side of the plurality of primary vents.

In some aspects, the techniques described herein relate to a battery pack venting system, wherein the cell stack axis, the primary vent axis, the first vent spout axis, and the second vent spout axis are parallel to each other.

In some aspects, the techniques described herein relate to a battery pack venting system, wherein each battery cell in the plurality of battery cells includes a case and one or more tab terminals extending from the case, wherein the one or more primary vents are each vertically above the cases of the plurality of battery cells, wherein the one or more vent spouts are vertically above the one or more tab terminals of the plurality of battery cells.

In some aspects, the techniques described herein relate to a battery pack venting system, wherein the plurality of battery cells are a plurality of pouch-style battery cells.

In some aspects, the techniques described herein relate to a battery pack venting system, including: a cell stack including a plurality of battery cells disposed along a cell stack axis, each battery cell within the plurality of battery cells having a case and at least one tab terminal projecting from the case; an enclosure assembly providing an interior that houses the cell stack, the enclosure assembly having an enclosure cover spanning the cell stack; one or more primary vents in the enclosure cover, the one or more primary vents aligned with the cases of the plurality of battery cells; and one or more vent spouts in the enclosure cover, the one or more vent spouts radially outside the cases of the plurality of battery cells relative to the cell stack axis.

In some aspects, the techniques described herein relate to a battery pack venting system, wherein the one or more vent spouts are raised relative to the one or more primary vents.

In some aspects, the techniques described herein relate to a battery pack venting system, wherein the enclosure cover is vertically above the cell stack.

In some aspects, the techniques described herein relate to a battery pack venting system, wherein the enclosure assembly is a first cell stack enclosure assembly, and further including a battery pack enclosure housing the first cell stack enclosure assembly and at least one second cell stack enclosure assembly.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electric vehicle having a traction battery pack.

FIG. 2 illustrates a perspective, partially expanded view of the traction battery pack from FIG. 1.

FIG. 3. illustrates a section view at line 3–3 in FIG. 2.

FIG. 4 illustrates a closeup view of an area of FIG. 3.

FIG. 5 illustrates a perspective view of a cell stack enclosure cover from the battery pack of FIG. 2.

FIG. 6 illustrates a closeup view of a vent spout of the cell stack enclosure cover shown in FIG. 5.

### DETAILED DESCRIPTION

This disclosure relates generally to a battery pack venting system and, in particular, to a venting system that has at least one primary vent and at least one vent spout. The vent spout can be used vent areas near terminals of a cell stack. Utilizing a vent spout can facilitate venting from these areas because the vent spout can contribute to a pressure differential that helps to draw vent byproducts through the vent spout.

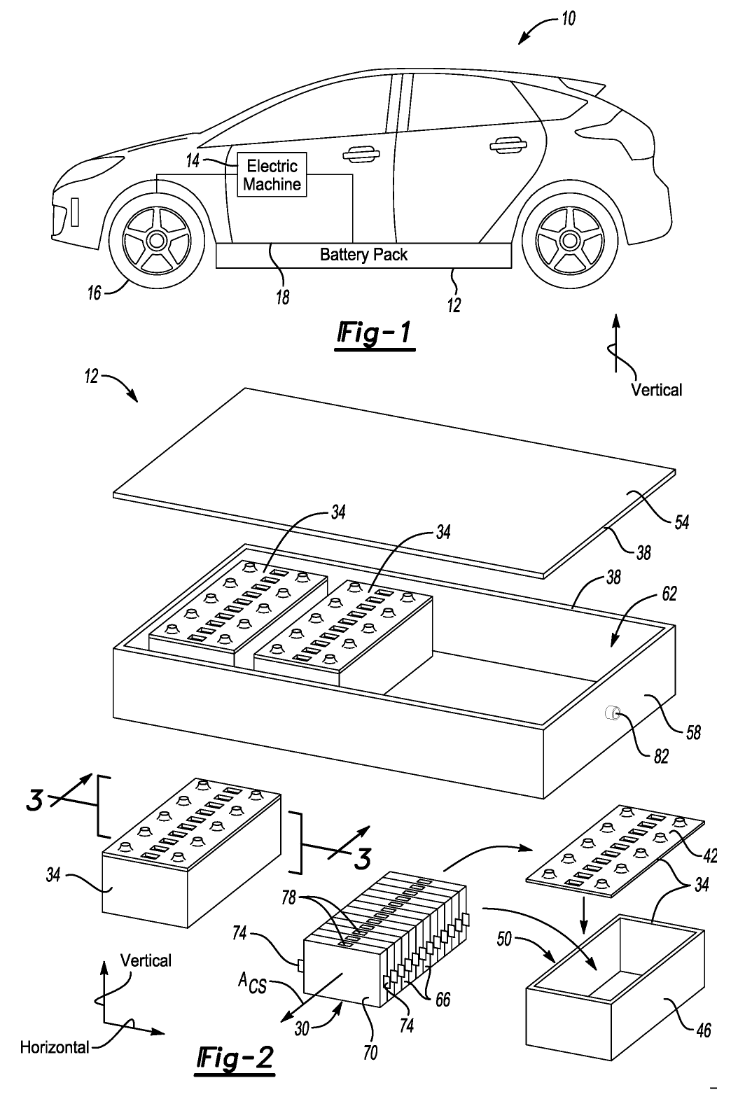

With reference to FIGS. 1 and 2, an electrified vehicle 10 includes a traction battery pack 12, an electric machine 14, and wheels 16. The battery pack 12 powers the electric machine 14, which converts electric power to torque to drive the wheels 16. The battery pack 12 is a traction battery pack as the battery pack 12 is used for electric propulsion.

The battery pack 12 is, in the exemplary embodiment, secured to an underbody 18 of the electrified vehicle 10 beneath and outside a passenger compartment of the electrified vehicle 10. The battery pack 12 could be located elsewhere on the electrified vehicle 10 in other examples.

The example vehicle 10 is a battery electric vehicle (BEV). In another example, the vehicle 10 could be another type of electrified vehicle, such as a hybrid electric vehicle (HEV), plug-in hybrid electric vehicle (PHEV), or a conventional vehicle. A hybrid electric vehicle selectively drives wheels using torque provided by an internal combustion engine instead of, or in addition to, an electric machine. Generally, the electrified vehicle 10 could be any type of vehicle having a traction battery pack.

The example battery pack 12 includes a plurality of cell stacks 30, a plurality of cell stack enclosure assemblies 34, and a battery pack enclosure assembly 38. In the exemplary embodiment, each cell stack enclosure assembly 34 includes a cell stack enclosure cover 42 and a cell stack enclosure tray 46 that cooperate to establish an interior 50 that houses one of the cell stacks 30.

The example cell stack enclosure assemblies 34 each include six enclosure walls. The cell stack enclosure cover 42 provides one enclosure wall. The cell stack enclosure tray 46 provides the remaining enclosure walls.

The battery pack enclosure assembly 38 includes a battery pack enclosure cover 54 and a battery pack enclosure tray 58 that cooperate to establish an interior 62 that holds the cell stack enclosure assemblies 34, which contain the cell stacks 30. The battery pack enclosure cover 54 spans the cell stack 30 held within the respective battery pack enclosure tray 58.

The example battery pack enclosure assembly 38 includes six enclosure walls. The battery pack enclosure cover 54 provides a single battery pack enclosure wall. The battery pack enclosure tray 58 the remaining battery pack enclosure walls.

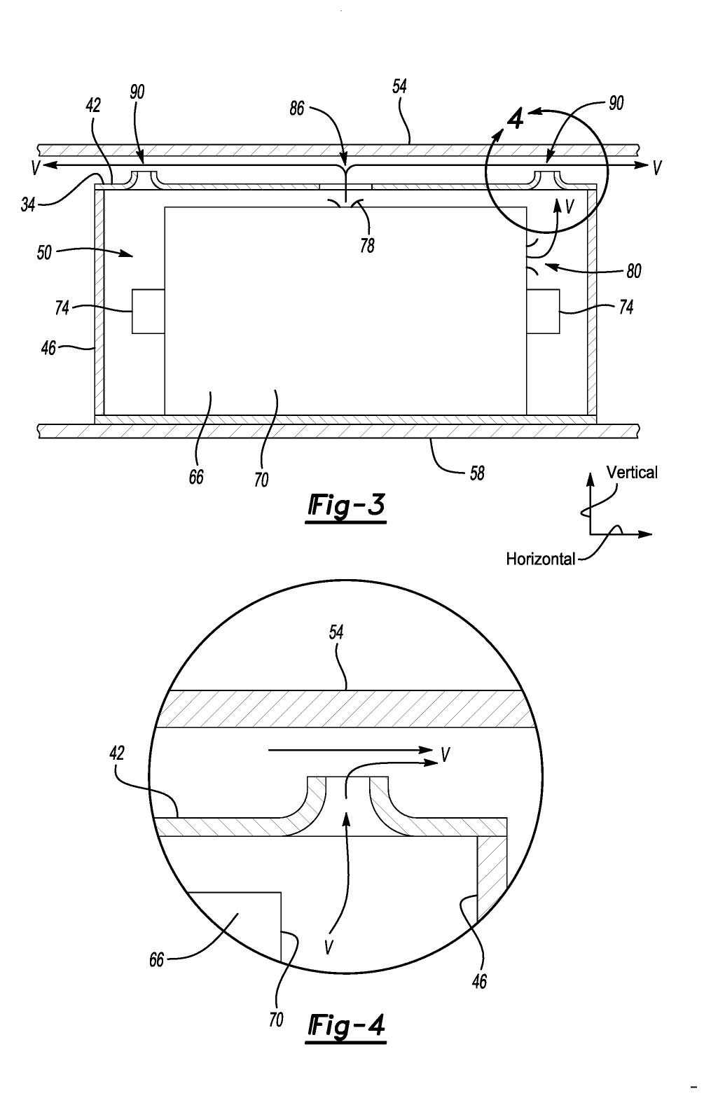

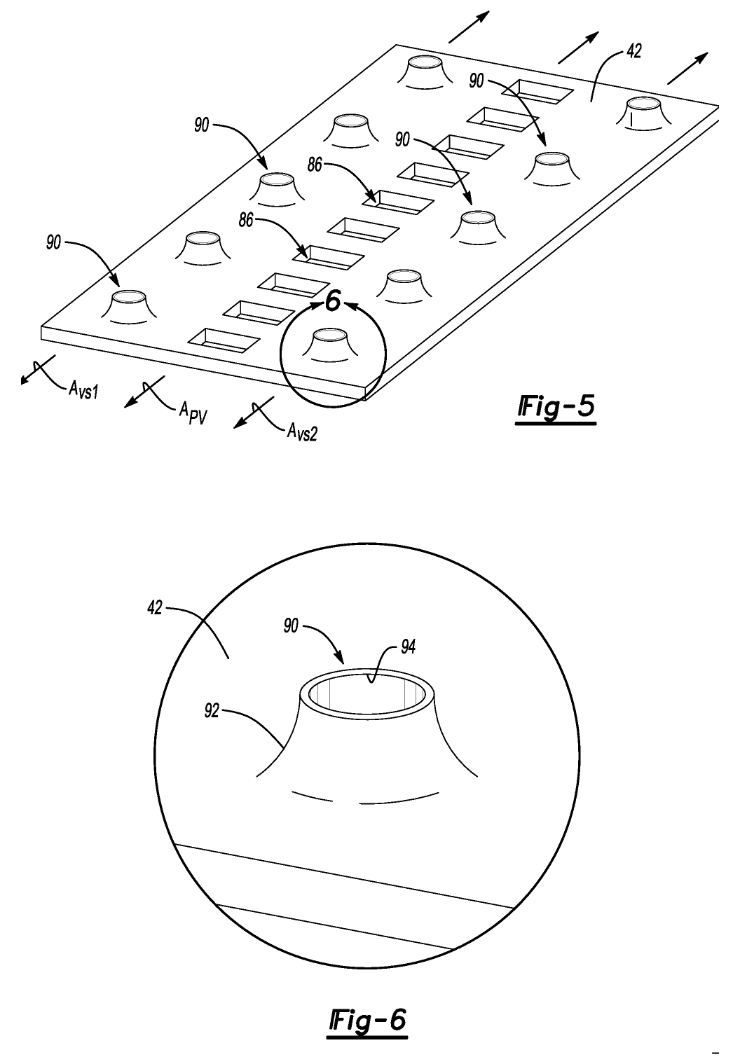

With reference now to FIGS. 3 –6, and continued reference to FIGS. 1 and 2, the cell stacks 30 of the battery pack 12 each include a plurality of individual battery cells 66 disposed along a respective cell stack axis A_{CS}.

In the exemplary embodiment, the battery cells 66 are lithium-ion pouch-style cells. However, battery cells having other geometries (cylindrical, prismatic, etc.), other chemistries (nickel-metal hydride, liquid-acid, etc.), or both could be alternatively utilized within the scope of this disclosure. The battery cells 66 each include a case 70 and two tab terminals 74 extending from opposing sides of the respective case 70. In other examples, a single tab terminal 74 could extend from the case 70, or more than two tab terminals 74 could extend from the case 70.

The battery cells 66 are disposed along the cell stack axis A_{CS} such that the tab terminals 74 project horizontally outward from the respective case 70. The tab terminals 74 can be operatively coupled to, for example, busbars within the respective cell stack enclosure assembly 34. Vertical and horizontal, for purposes of this disclosure, are with reference to ground and a general orientation of the vehicle 10 during operation.

. From time to time, a thermal event can occur that leads to an increase in pressure and temperature in the cases 70 of one or more of the battery cells 66. The increasing pressure and temperature can rupture an area 78 in a top surface of the respective battery cell 66 to release vent byproducts V from an interior of the respective case 70 into the interior 50 of the cell stack enclosure assembly 34. While the figures show a single one of the battery cells 66 venting the vent byproducts V, more than one of the battery cells 66 can release the vent byproducts V at the same time.

The increase in pressure and temperature within the case 70 of one of the battery cells 66 can rupture the respective case 70 in the areas 78. The increasing pressure and temperature can instead or additionally rupture other areas of the case 70, such as, as shown, an area 80 near the tab terminals 74. The vent byproducts V can escape from these ruptured areas of the case 70 instead of, or in addition to, being released through the respective areas 78..

The battery pack 12 includes various vents utilized to communicate the vent byproducts V from the battery pack enclosure assembly 38 into an area of the interior 62 that is outside the battery pack enclosure assemblies 38 held within the interior 62. The vent byproducts V can be then be released through a battery pack vent 82 to an area surrounding the battery pack 12. The vent byproducts can include gases, debris, particulates, etc.

In the exemplary embodiment, the cell stack enclosure assemblies 34 include two types of vents utilized to communicate the vent byproducts V from the interior 50 through the cell stack enclosure assemblies 34 to the interior 62 of the battery pack enclosure assembly 38. From this position, the vent byproducts V can be communicated to the battery pack vent 82 and discharged from the battery pack 12.

In particular, the cell stack enclosure covers 42 each include a plurality of primary vents 86disposed along a primary vent axis A_{PV}, a first plurality of vent spouts 90 disposed along a first vent spout axis A_{VS1}, and a second plurality of vent spouts 90 disposed along a second vent spout axis A_{VS2}. The vent spouts 90 establish raised areas of the cell stack enclosure covers 42.

In this example, the primary vents 86 are disposed between the first vent spouts 90 and the second vent spouts 90. The primary vent axis A_{PV}, the first vent spout axis A_{VS1}, and the second vent spout axis A_{VS1} are parallel to each other in this example. The example primary vent axis A_{PV}, the first vent spout axis A_{VS1}, and the second vent spout axis A_{VS1} are also parallel to the cell stack axis A_{CS}. The plurality of primary vents 86 are aligned with the cases 70 and the areas 78 of the battery cells 66.

The cell stack enclosure cover 42 is disposed vertically above the cell stack 30 that is contained within the respective cell stack enclosure assembly 34. The primary vents 86 are disposed vertically directly above the cases 70 of the battery cells 66. The first vent spouts 90 are disposed vertically directly above tab terminals 74 on a first side of the cell stack 30. The vent spouts 90 are disposed above tab terminals 74 on an opposite, second side of the cell stack 30.

The vent spouts 90 are elevated or raised relative to the primary vents 86. In particular, each of the vent spouts 90 includes a collar 92 projecting from surrounding portions of the cell stack enclosure cover 42. The collar 92 is a frustoconical portion of the vent spouts 90 in this example. The collar 92 circumscribes an outlet 94 from the vent spout 90. Outlets of the primary vents 86 are a first distance from the interior. The outlets 94 are a second distance from the interior 50. The first distance is less than the second distance. Like the primary vents 86, the vent spouts 90 can be covered by membranes that rupture when venting through the vent spouts 90.

Due to the vent spouts 90 projecting from the surrounding portions of the cell stack enclosure cover 42, the vent spouts 90 open to an area within the battery pack enclosure assembly 38 that is vertically above a position where the primary vents 86 open to the interior 62 of the battery pack enclosure assembly 38. Put another way, the vent spouts 90 have outlets 94 that are raised relative to the primary vents 86. The vent spouts 90 project into the flow path of the vent byproducts V moving horizontally along the cell stack enclosure cover 42 from the primary vents 86.

In this example, vent byproducts V released through the areas 78 can initially move through the primary vent 86 into an area of the interior 62 that is outside the cell stack enclosure assembly 34. Each primary vent 86 could be covered by a membrane that ruptures in response to vent byproducts V being released from the battery cells 66.

After passing through the primary vent 86, the vent byproducts V contact an underside of the battery pack enclosure cover 54 and are redirected horizontally outward, which is radially away from the cell stack axis A_{CS}. The vent byproducts V flow between the cell stack enclosure cover 42 and the battery pack enclosure cover 54 outward toward the vent spouts 90.

The vent byproducts V then flow over one or more of the vent spouts 90. The flow of the vent byproducts V over the vent spouts 90 can facilitate drawing vent byproducts V that have been vented from the respective case 70 through the area 80 near the tab terminals 74 through the vent spouts 90. The vent byproducts V that pass through the vent spouts 90 combine with the vent byproducts V that moved through the primary vents 86. The vent byproducts V are then moved through the battery pack vent 82 to an area outside the battery pack 12.

As can be appreciated, the movement of the vent byproducts V over the outlet 94 of one of the vent spouts 90 leads to a lower pressure across the outlet 94 than within the cell stack enclosure assembly 34. This facilitates venting of vent byproducts V from areas outside the cases 70 of the battery cells 66. This can be particularly helpful to draw debris and particulates of the vent byproducts V through the vent spouts 90.

While the example battery pack venting system utilizes the primary vents 86 and the vent spouts 90 in connection with the cell stack enclosure assembly 34, the venting system having the primary vents 86 and the vent spouts 90 could also be utilized within a battery pack enclosure assembly, such as the battery pack enclosure assembly 38 of the battery pack 12.

In particular, the venting system could be incorporated into the battery pack enclosure cover 54 of the battery pack 12 and used to facilitate drawing vent byproducts from the interior 62 through the battery pack enclosure cover 54.

Features of the disclosed example include incorporating vent spouts into a battery pack venting system to establish pressure differentials that facilitate movement of vent byproducts V through the vent spouts. The vent spouts can be characterized as trumpet-shaped vent risers in some examples.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack venting system, comprising:
a cell stack including a plurality of battery cells disposed along a cell stack axis;
an enclosure assembly providing an interior that houses the cell stack, the enclosure assembly having a first enclosure wall and a plurality of second enclosure walls;
one or more primary vents in the first enclosure wall; and
one or more vent spouts in the first enclosure wall.

2. The battery pack venting system, of claim 1, wherein the one or more vent spouts each include a collar that projects away from the interior and circumscribes an vent spout outlet.

3. The battery pack venting system of claim 1, wherein the one or more primary vents each include a primary vent outlet that is a first distance from the interior, and the one or more vent spouts each include a vent spout outlet that is a second distance from the interior, the first distance less than the second distance.

4. The battery pack venting system of claim 1, wherein the one or more vent spouts each include a vent spout outlet that is elevated relative to the one or more primary vents.

5. The battery pack venting system of claim 1, wherein the first enclosure wall is an enclosure cover.

6. The battery pack venting system of claim 1, wherein the enclosure assembly is a cell stack enclosure assembly, and further comprising a battery pack enclosure assembly that houses the cell stack enclosure assembly.

7. The battery pack venting system of claim 6, wherein the one or more primary vents and the one or more vent spouts open to an interior of the battery pack enclosure assembly that is outside the cell stack enclosure assembly.

8. The battery pack venting system of claim 6, wherein the cell stack enclosure assembly is a first cell stack enclosure assembly, and further comprising at least one second cell stack enclosure assembly housed within the battery pack enclosure assembly.

9. The battery pack venting system of claim 1, wherein the one or more vent spouts each include a frustoconical portion.

10. The battery pack venting system of claim 1, wherein the one or more primary vents includes a plurality of primary vents disposed along an primary vent axis.

11. The battery pack venting system of claim 10, wherein the one or more vent spouts comprises a plurality of vent spouts disposed along a vent spout axis.

12. The battery pack venting system of claim 11, wherein the plurality of vent spouts disposed along a vent spout axis is a first plurality of vent spouts disposed along a first vent spout axis, wherein the one or more vent spouts comprises a second plurality of vent spouts disposed along a second vent spout axis.

13. The battery pack venting system of claim 12, wherein the first plurality of vent spouts are on a first side of the plurality of primary vents, wherein the second plurality of vent spouts are on an opposite, second side of the plurality of primary vents.

14. The battery pack venting system of claim 13, wherein the cell stack axis, the primary vent axis, the first vent spout axis, and the second vent spout axis are parallel to each other.

15. The battery pack venting system of claim 10, wherein each battery cell in the plurality of battery cells includes a case and one or more tab terminals extending from the case, wherein the one or more primary vents are each vertically above the cases of the plurality of battery cells, wherein the one or more vent spouts are vertically above the one or more tab terminals of the plurality of battery cells.

16. The battery pack venting system of claim 1, wherein the plurality of battery cells are a plurality of pouch-style battery cells.

17. A battery pack venting system, comprising:
a cell stack including a plurality of battery cells disposed along a cell stack axis, each battery cell within the plurality of battery cells having a case and at least one tab terminal projecting from the case;
an enclosure assembly providing an interior that houses the cell stack, the enclosure assembly having an enclosure cover spanning the cell stack;
one or more primary vents in the enclosure cover, the one or more primary vents aligned with the cases of the plurality of battery cells; and
one or more vent spouts in the enclosure cover, the one or more vent spouts radially outside the cases of the plurality of battery cells relative to the cell stack axis.

18. The battery pack venting system of claim 17, wherein the one or more vent spouts are raised relative to the one or more primary vents.

19. The battery pack venting system of claim 17, wherein the enclosure cover is vertically above the cell stack.

20. The battery pack venting system of claim 17,
wherein the enclosure assembly is a first cell stack enclosure assembly, and
further comprising a battery pack enclosure housing the first cell stack enclosure assembly and at least one second cell stack enclosure assembly.
